(19) United States
(12) Patent Application Publication
(10) Pub. No.: US 2014/0077632 A1
(43) Pub. Date: Mar. 20, 2014

(54) ELECTRIC MACHINE WITH THERMAL TRANSFER BY LIQUID

(71) Applicant: Remy Technologies, LLC, Pendleton, IN (US)

(72) Inventors: Joshua King, Pendleton, IN (US); Colin Hamer, Noblesville, IN (US)

(21) Appl. No.: 14/026,723

(22) Filed: Sep. 13, 2013

Related U.S. Application Data
(60) Provisional application No. 61/701,376, filed on Sep. 14, 2012.

(51) Int. Cl. H02K 9/19; H02K 15/03

(52) U.S. Cl. CPC H02K 9/19; H02K 15/03
USPC 310/54; 29/598

(57) ABSTRACT

A rotor of an internal permanent magnet (IPM) electric machine includes a core having first and second axial ends, longitudinal channels extending between the ends, and a plurality of permanent magnets disposed in the channels. A first conical spring washer having a circumferential edge is secured to the first axial end and a second conical spring washer having a circumferential edge is secured to the second axial end. Space between the first conical spring washer and the first axial end is in fluid communication, via the channels, with space between the second conical spring washer and the second axial end. A method includes stacking and aligning laminations on a shaft to thereby form a rotor core, placing a conical spring washer onto the shaft at each axial end of the lamination stack, and tightening the conical spring washers onto the shaft, whereby the conical spring washers compress the lamination stack. A method of cooling magnets of an internal permanent magnet (IPM) electric machine includes enclosing each axial end of a rotor core with a conical spring washer to form two respective end cavities, and transferring coolant between the end cavities, thereby passing the coolant by the magnets.

### BACKGROUND

The present invention is directed generally to improving the performance and efficiency of an internal permanent magnet (IPM) type motor/generator and, more particularly, to the transfer of heat from a rotor core.

The use of permanent magnets generally improves performance and efficiency of electric machines. For example, an IPM type machine has magnetic torque and reluctance torque with high torque density, and generally provides constant power output over a wide range of operating conditions. An IPM electric machine generally operates with low torque ripple and low audible noise. The permanent magnets may be placed on the outer perimeter of the machine's rotor (e.g., surface mount) or in an interior portion thereof. IPM electric machines may be employed in hybrid or all electric vehicles, for example operating as a generator when the vehicle is braking and as a motor when the vehicle is accelerating. Other applications may employ IPM electrical machines exclusively as motors, for example powering construction and agricultural machinery. An IPM electric machine may also be used exclusively as a generator.

There is generally a maximum power output according to the electromagnetic limit of an electric machine, where this ideal maximum power theoretically exists in a case where the electric machine experiences no losses. Such ideal power can be expressed as a maximum power for a short duration of time. In an actual electric machine operating in the real world, there are losses due to heat, friction, decoupling, and others. A maximum continuous power that is produced when the electric machine operates continuously may be increased by removing heat from the electric machine. A buildup of heat limits the ability of the machine to run continuously. By removal of heat, the continuous power capacity of the electric machine is increased.

One source of heat in IPM electric machines is the permanent magnets within the rotor. Typical design of magnet channels includes a matching profile in the magnetizing direction and a circular or curved profile in the non-magnetizing direction, and this basic design concept directs the flux path effectively and efficiently. However, thermal management is critical in the spaces surrounding permanent magnets because the magnets are sensitive to heat and will de-magnetize when subjected to excessive heat generated from power losses in the motor. Conventional IPM rotors are not adequately cooled, resulting in lower machine efficiency and output, and excessive heat may result in demagnetization of permanent magnets and/or mechanical problems.

### SUMMARY

It is therefore desirable to obviate the above-mentioned disadvantages by providing a rotor cooling system that transfers heat away from permanent magnets by passing a coolant in close proximity to the magnets. Coolant pressure is partially regulated by a rotor structure.

According to an exemplary embodiment, a rotor of an internal permanent magnet (IPM) electric machine includes a core having first and second axial ends, longitudinal channels extending between the ends, and a plurality of permanent magnets disposed in the channels. A first conical spring washer having a circumferential edge is secured to the first axial end and a second conical spring washer having a circumferential edge is secured to the second axial end. Space between the first conical spring washer and the first axial end is in fluid communication, via the channels, with space between the second conical spring washer and the second axial end.

According to another exemplary embodiment, a method includes stacking and aligning laminations on a shaft to thereby form a rotor core, placing a conical spring washer onto the shaft at each axial end of the lamination stack, and tightening the conical spring washers onto the shaft, whereby the conical spring washers compress the lamination stack.

According to a further exemplary embodiment, a method of cooling magnets of an internal permanent magnet (IPM) electric machine includes enclosing each axial end of a rotor core with a conical spring washer to form two respective end cavities, and transferring coolant between the end cavities, thereby passing the coolant by the magnets.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an exemplary electric machine having a stator that includes stator windings;

FIG. 2 is a perspective view of an IPM rotor 24 having a hub assembly;

FIG. 3 shows an exemplary permanent magnet;

FIG. 4 is a top plan view of a rotor assembly having sets of magnet channels;

FIG. 5 is an enlarged top view of one magnet channel set for the rotor assembly of FIG. 4;

FIG. 6 is a cross-sectional schematic view of a rotor assembly of an exemplary embodiment;

FIG. 7 is a cross-sectional schematic view of an exemplary conical spring washer;

FIG. 8 is an exemplary exploded view of a stacking arrangement for conical spring washers; and

FIG. 9 is a cross-sectional view of an electric machine having a coolant system that utilizes a conical spring washer, according to an exemplary embodiment.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

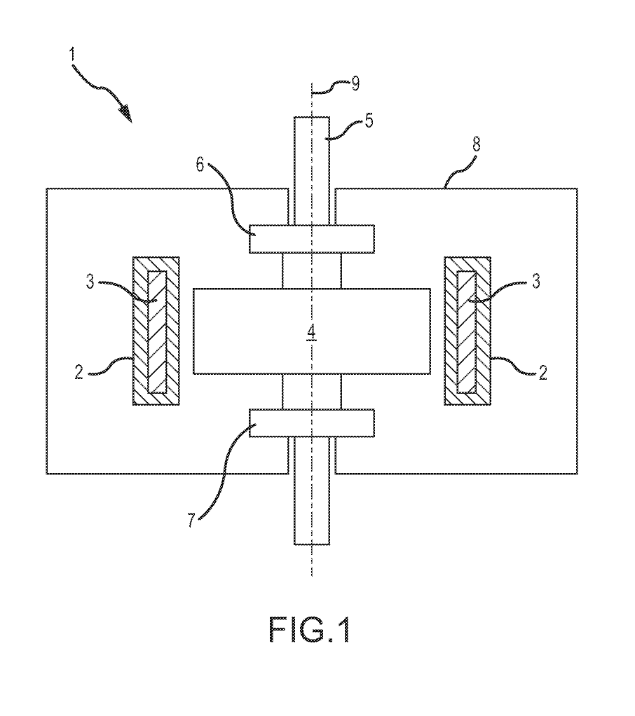

FIG. 1 is a schematic view of an exemplary electric machine 1 having a stator 2 that includes stator windings 3 such as one or more coils. An annular rotor body 4 contains permanent magnets. Rotor body 4 is part of a rotor that includes an output shaft 5 supported by a front bearing assembly 6 and a rear bearing assembly 7. Bearing assemblies 6, 7 are secured to a housing 8. Typically, stator 2 and rotor body 4 are essentially cylindrical in shape and are concentric with a central longitudinal axis 9. Although rotor body 4 is shown radially inward of stator 2, rotor body 4 in various embodiments may alternatively be formed radially outward of stator 2. Electric machine 1 may be an induction motor/generator or other device. In an exemplary embodiment, electric machine 1 may be a traction motor for a hybrid or electric type vehicle. Housing 8 may have a plurality of longitudinally extending fins (not shown) formed to be spaced from one another on a housing external surface for dissipating heat produced in the stator windings 3.

A rotor core 4 of an IPM electrical machine is typically manufactured by stamping and stacking a large number of sheet metal laminations. Axially or longitudinally extending magnet channels may be formed by magnet slots of laminations being stacked and aligned on top of one another. Magnet channels for receiving one or more permanent magnet(s) are typically located near the rotor surface facing stator 2. Motor efficiency is generally improved by minimizing the distance between the rotor magnets and the stator. Various methods have been used to install permanent magnets in the magnet channels of the rotor. These methods may leave a void space/opening within the magnet channel after installation of the magnet. Typically, such openings are specifically designed to help concentrate the magnetic flux in the rotor and thereby optimize performance of the electric machine.

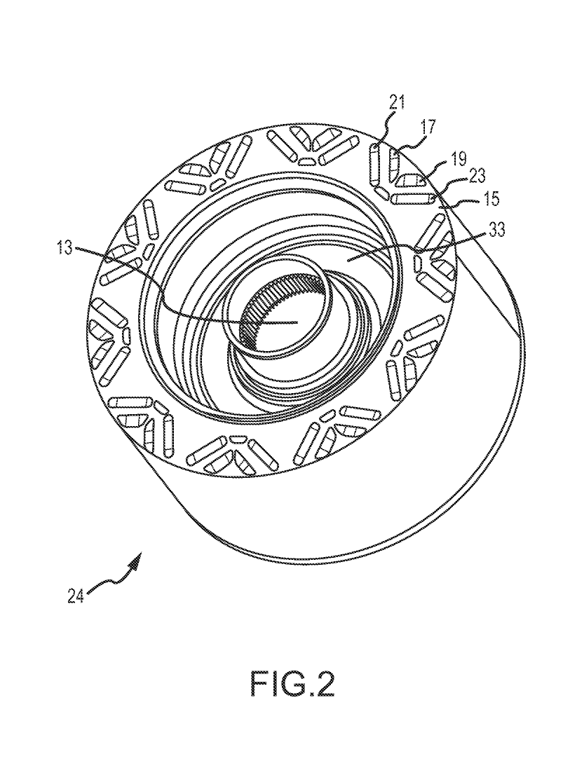

FIG. 2 is a perspective view of an IPM rotor 24 having a hub assembly 33 with a center aperture 13 for securing rotor 24 to shaft 5. Rotor 24 includes a rotor core 15 that may be formed, for example, in a known manner as a stack of individual metal laminations, for example steel. Rotor core 15 includes a plurality of axially-extending magnet channels/slots 17, 19, 21, 23 each having an elongated shape, for example an elongated oval shape. Although variously illustrated herein with sharp corners and ends, magnet channels 17, 19, 21, 23 typically have rounded ends for reducing stress concentrations in the rotor laminations.

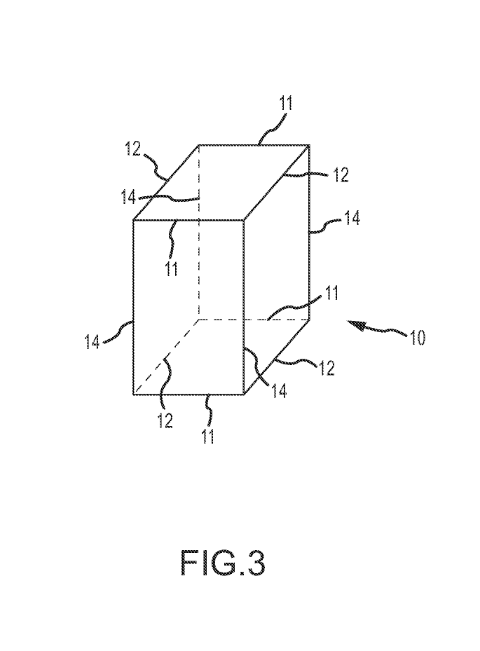

FIG. 3 shows an exemplary permanent magnet 10 formed as a rectangular column with a width defined as the linear dimension of any edge 11, a length defined as the linear dimension of any edge 12, and a height defined as a linear dimension of any edge 14. While a regular rectangular solid is described for ease of discussion, a permanent magnet of the various embodiments may have any appropriate shape. For example, magnets 10 may have rounded ends, sides, and/or corners. Respective areas bounded by edges 11, 12 may herein be referred to as magnet top and bottom. Respective areas bounded by edges 11, 14 may herein be referred to as magnet ends. Respective areas bounded by edges 12, 14 may herein be referred to as magnet lateral sides. Magnets 10 may have any appropriate size for being installed into the various magnet channels/slots 17, 19, 21, 23. Magnet 10 may be formed as a group of individual magnet pieces, such as by axially segmenting magnet 10 to allow for thermal expansion and other considerations. Magnets 10 are typically formed of rare-earth materials such as Nd (neodymium) that have a high magnetic flux density. Nd magnets may deteriorate and become demagnetized in the event that operating temperature is too high. When an electric machine is operating under a high temperature condition, the permanent magnets become overheated. For example, when a Nd magnet reaches approximately 320 degrees Celsius, it becomes demagnetized standing alone. When a combination of the temperature and the electric current of the machine becomes large, then demagnetization may also occur. For example, demagnetization can occur at a temperature of one hundred degrees C. and a current of two thousand amperes, or at a temperature of two hundred degrees C. and a current of two hundred amperes. As an electric machine is pushed to achieve greater performance, the increase in machine power consumption and associated power losses in the form of heat tests the stability of the magnets themselves. Therefore, it may be necessary to add Dy (dysprosium) to the magnet compound to increase the magnets' resistance to demagnetization. For example, a neodymium-iron-boron magnet may have up to six percent of the Nd replaced by Dy, thereby increasing coercivity and resilience of magnets 10. Although dysprosium may be utilized for preventing demagnetization of magnets 10, it is expensive, and the substitution of any filler for Nd reduces the nominal magnetic field strength. The Dy substitution may allow an electric machine to run hotter but with less relative magnetic field strength.

The example of FIG. 2 shows ten sets of magnet channels, where each set includes magnet channels 17, 19, 21, 23, and where the sets define alternating poles (e.g., N-S-N-S, etc.) in a circumferential direction. Any appropriate number of magnet sets may be used for a given application. Magnet channels 17, 19, 21, 23 and corresponding magnets 10 may extend substantially the entire axial length of rotor core 15. As noted above, a magnet 10 may be formed as a group of individual magnet pieces, such as by axially segmenting magnet 10.

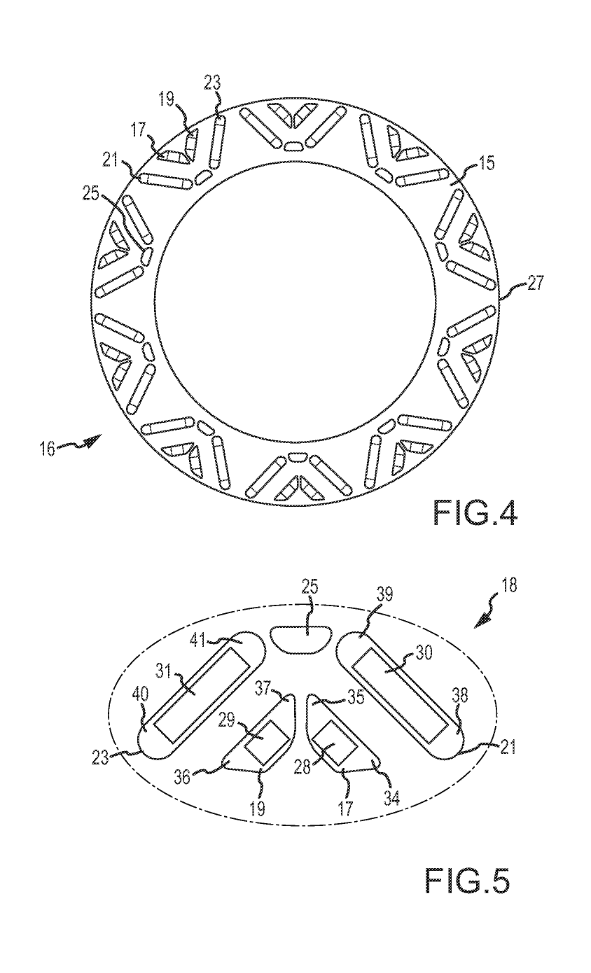

FIG. 4 is a top plan view of a rotor assembly 16 having ten sets of magnet channels 17, 19, 21, 23, and FIG. 5 is an enlarged top view of one magnet set 18 thereof. Although various ones of magnet channels 17, 19, 21, 23 are shown with sharp edges, such edges may be rounded. One of the simplest methods of installing a permanent magnet in a rotor is to simply slide the magnet into the magnet channel and retain the magnet within the magnet channel by a press-fit engagement. This type of installation will typically result in axially extending void spaces or gaps located around the magnet. After a permanent magnet 28 has been placed into magnet channel 17, there are gaps 34, 35 between the magnet 28 ends and the interior wall of channel 17. Similarly, after a permanent magnet 29 has been placed into magnet channel 19, there are gaps 36, 37 between the magnet 29 ends and the interior wall of channel 19. After a permanent magnet 30 has been placed into magnet channel 21, there are gaps 38, 39 between the magnet 30 ends and the interior wall of channel 21. After a permanent magnet 31 has been placed into magnet channel 23, there are gaps 34, 35 between the magnet 31 ends and the interior wall of channel 23. Gaps 34-41 prevent a short-circuiting of magnetic flux when a direction of magnetization is orthogonal to the magnet ends, and help saturate the lamination steel. The alignment of gaps 34-41 forms longitudinally extending magnet channels 17, 19, 21, 23. When the magnet channels are located very close to the rotor exterior to maximize motor efficiency, only a thin bridge of rotor core material formed by the stacked laminations of the rotor separates magnet channels 17, 19, 21, 23 from the exterior surface 27 of the rotor.

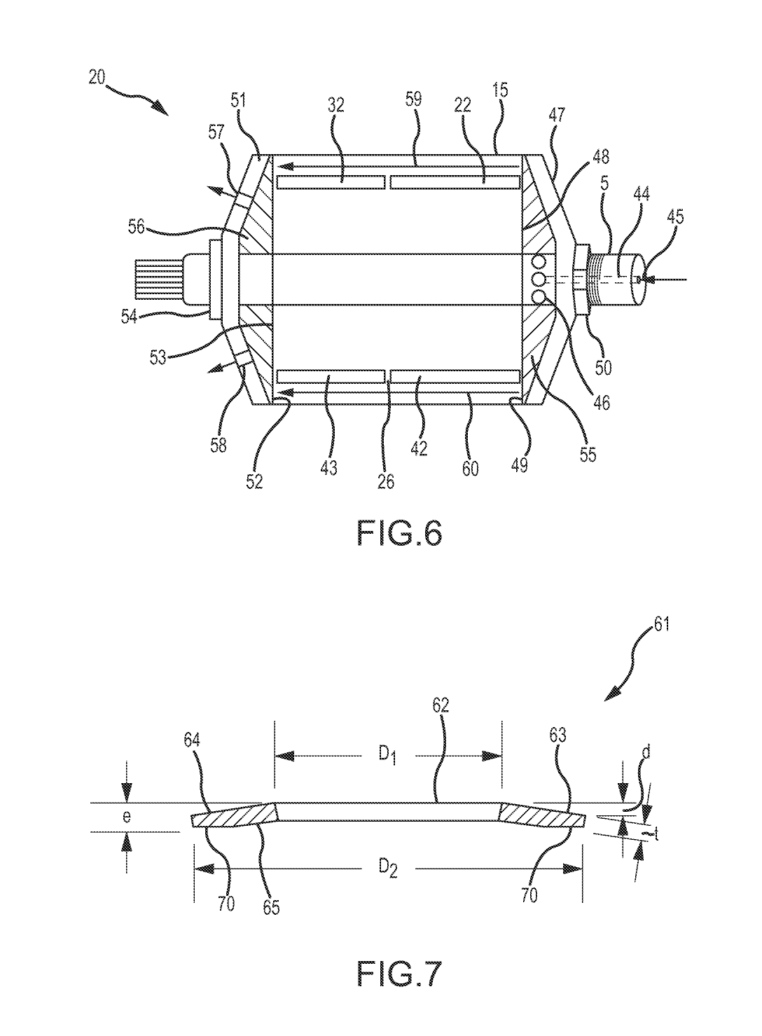

FIG. 6 is a cross-sectional schematic view of a rotor assembly 20 in an exemplary embodiment. Shaft 5 extends through rotor core 15 having a number of longitudinally extending magnet channels 17, 19, 21, 23 (FIG. 2). Magnets 22, 32 are disposed in a magnet channel and together form an axially segmented magnet. Magnets 42, 43 are disposed in another magnet channel and together form another axially segmented magnet. A thermally conductive material (not shown) is placed in spaces 26 between axially segmented magnets 10. An epoxy, resin, thermoset (potting compound), nylon, or like materials may be injected for securing NdFeB magnets in rotor core 15. For example, axially segmented permanent magnets 22, 32 may be molded together, cured into a unitary piece, placed and aligned in a magnet channel of rotor body 15, and may then be secured by additional adhesive or resin if necessary. In some embodiments, a vacuum-assisted resin transfer process may be used. In such a case, magnet channels 17, 19, 21, 23 may be masked to maintain axial flow paths therein. In other embodiments, a thermally conductive adhesive device (not shown) may be attached between an axially segmented pair of magnets 10. The adhesive device and magnets are inserted into a magnet channel, and when the rotor is heated, the magnet pair is thereby axially glued together without blocking the flow of coolant through the channel. Other methods may be used to install, thermally connect, and secure permanent magnets 10 without blocking coolant flow through the magnet channels as described herein below. However, once permanent magnets 10 have been installed, secured, and magnetized, there is little chance of subsequent magnet movement due to the strength of the magnetic field produced by a typical neodymium-iron-boron magnet.

One end of shaft 5 has a center bore 44 and a fluid inlet 45. Bore 44 extends axially to a manifold that includes a number of radially extending holes 46. A first conical spring washer 47 is mounted onto shaft 5 so that its outer circumferential edge 49 abuts the axial end 48 of rotor body 15. A second conical spring washer 51 is mounted onto shaft 5 so that its outer circumferential edge 52 abuts the axial end 53 of rotor body 15. A nut 50 and associated structure (not shown) such as washers, spring carrier, O-ring, etc. is tightened onto a threaded portion of shaft 5 to secure first conical spring washer 47, and a nut 54 or other appropriate structure secures second conical spring washer 51 to shaft 5. Nuts 50, 54 are tightened so that conical spring washers 47, 51 compress the laminations of rotor body 15, and annular edges 49, 52 form seals against respective axial ends 48, 53. The dome shape of conical spring washers 47, 51 forms cavities 55, 56 between springs 47, 51 and respective axial ends 48, 53. As used herein, the term “conical spring washer” refers to a type of washer or spring that includes a Belleville washer and similar devices. Each conical spring washer 47, 51 may be a single spring or may be provided as a stack of springs, as discussed further below. The compression against axial ends 48, 53 provided by conical spring washers 47, 51 may be sufficient to eliminate the conventional need for bonding/securing individual laminations together such as by welding, staking, adhering, etc. Such reduces cost and electrical losses, and improves performance and efficiency of electric machine 1. For example, a conical spring washer formed as a steel Belleville washer having a thickness of 4 mm may provide approximately 13 kN (kilo-Newtons) of force at each end of the lamination stack.

In operation, a coolant such as oil is pumped into inlet 45 and flows through bore 44 and holes 46 into cavity 55. Cavity 55 fills, and the coolant passes through magnet channels 17, 19, 21, 23 and around magnets 22, 32, 42, 43. The generally axial coolant flow 59, 60 removes heat of magnets 22, 32, 42, 43 by convection, thereby providing a direct cooling effect. The heated coolant is forced along the magnets and laminations and into cavity 56. Cavity 56 fills with coolant. The continuous pressure keeps rotor assembly 20 full of coolant. Continued flow forces the hot coolant out of cavity 56 through exit nozzles 57, 58. The internal coolant pressure is partially regulated by this ejection of hot coolant. Heat is thereby removed from rotor core 15 and magnets 10, resulting in a higher power capacity and/or a smaller size of electric machine 1. Gaps 34-41 (e.g., FIG. 5) are typically large enough to allow coolant to flow over a high percentage of magnet surface area, especially when magnets 10 are set in place by their abutment with a minimized alignment structure (not shown) disposed within magnet channels 17, 19, 21, 23. The internal pressure is typically sufficient to assure a high flow rate and continuous operation with rotor core 15 completely full of coolant and completely devoid of air. In particular, cavities 55, 56 and magnet channels 17, 19, 21, 23 remain filled with flowing coolant during continuous operation.

In the event of an over-pressurization, the coolant pressure forces conical spring washers 47, 51 away from respective axial ends 48, 53 of rotor body 15 until the pressure returns to a level where the spring force of conical spring washers 47, 51 is able to overcome the force of such pressure. Such an over-pressurization event, however, may be due to a catastrophic system failure and, accordingly, an axial movement of a conical spring washer 47, 51 that breaks away from rotor core 15 will typically only occur in extreme circumstances. Actual breaking away may be manifested as a small portion of a conical spring washer lifting slightly for a short time or, in the event of a catastrophic increase in pressure, by a lifting with a longer time duration and/or a greater displacement. There may be a selected portion of one or both conical spring washers 47, 51 designed as a pressure blow-off location, such as by having a lighter gauge material in such portion. The use of multiple stacked conical spring washers may prevent deformation of the spring material in the event of a relatively large displacement. In an exemplary embodiment, a 30 PSI line pressure may create over 1,000 pounds of pressure inside cavities 55, 56. By comparison, under normal conditions, conical spring washers 47, 51 have a spring structure and composition that allows a slight temporary flexing from increased internal pressure, whereby the sealing between conical spring washers 47, 51 and respective axial ends 48, 53 is not interrupted. Under such normal conditions, conical spring washers 47, 51 exert an axial force that compresses rotor body 15 and maintains a tight annular seal at each axial end.

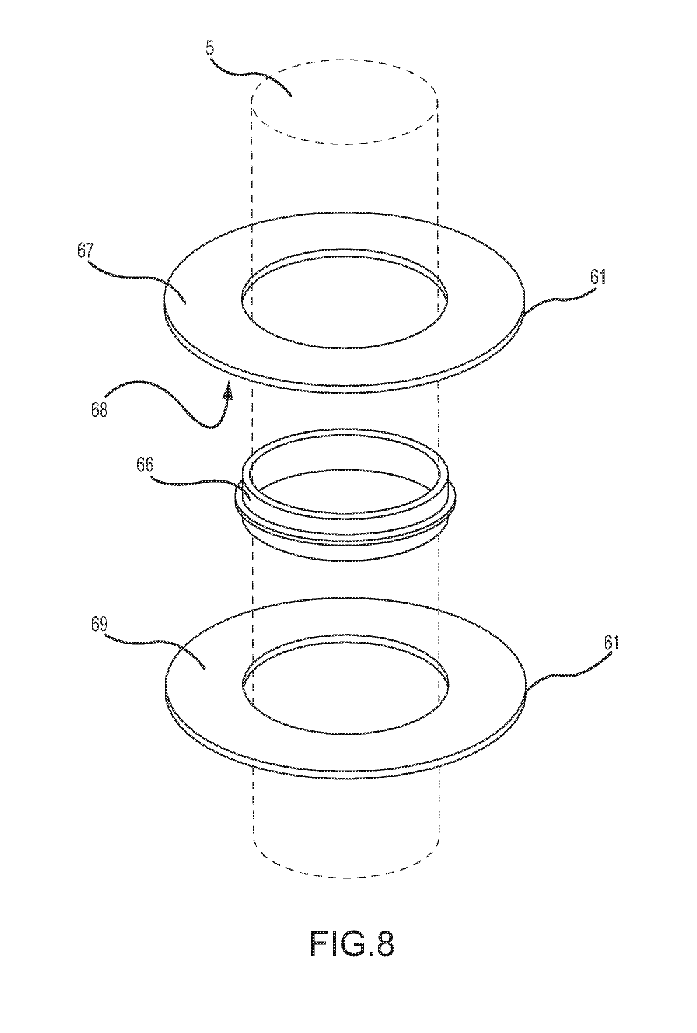

FIG. 7 is a cross-sectional schematic view of an exemplary conical spring washer 61. Conical spring washer 61 is typically formed of high alloy content spring steel or other metals for meeting specific performance requirements, such as high fatigue life, minimum relaxation, spring rate, deflection percentage, size, weight, and others. Although illustrated with a substantially linear profile having straight spring portions 63, conical spring washer 61 typically has a contoured shape such as a frusto-conical shape and may have a flat top portion for mounting purposes. Conical spring washers 61 are typically designed to be loaded in the axial direction only and to have a small deflection. The dimension D₁ is the diameter of the center opening 62, for example approximating the diameter of shaft 5. The dimension D₂ is the outside diameter of spring 61, t is the thickness of the spring material, d is the maximum deflection of spring 61 when compressed, and e is the overall height/thickness of spring 61 in an uncompressed state. Since conical spring washer 61 has a simple structure, it may be easily modified and manufactured. For example, spring portion 63 may have differing thicknesses and/or be formed of different material compositions in certain sectors thereof, such as for obtaining a specific spring rate at a given load and temperature. Generally, conical spring washer 61 has a convex side 64 and a concave side 65. The outer periphery of concave side 65 has a planar, annular beveled portion 70, so that when conical spring washer 61 is compressed against an axial end 48, 53 of rotor body 15, beveled portion 70 lies flat against such outer end 48, 53, whereby a tight seal is formed. Alternatively, the annular outer edge(s) of conical spring washers 47, 51 may be formed as a ridge or raised portion that is beveled. Other designs, such as those using a gasket or the like, may be utilized for assuring a tight and consistent surface contact between the annular outer edge(s) of conical spring washers 47, 51 and the respective axial ends 48, 53, without incurring point loading or gaps.

FIG. 8 is an exemplary exploded view of a stacking arrangement for conical spring washers 61. Multiple conical spring washers 61 may be stacked to modify the spring constant or the amount of deflection. Stacking in the same direction/orientation adds the spring constants in parallel and creates a stiffer joint. Stacking in an alternating direction (e.g., two adjacent/touching convex sides or two adjacent concave sides) is a series configuration that results in a lower spring constant and greater deflection. By changing the stacking pattern, a specific spring constant and deflection may be easily achieved. As shown, two conical spring washers 61 are stacked on shaft 5. The dimension D₁, diameter of the center opening 62 (FIG. 7), is typically slightly greater than the diameter of shaft 5. A spring carrier 66 may optionally be provided to precisely space springs 61 a small distance apart from one another, and to improve sealing between springs 61 and shaft 5. The illustrated top conical spring washer 61 has a top side 67 and a bottom side 68. The bottom spring 61 has a top side 69. When bottom conical spring washer 61 is placed onto rotor body 15, surface 69 is convex. In such a case, when adjacent side 68 is concave, the stack is a parallel arrangement; when adjacent side 68 is convex, the stack has a series configuration.

In an exemplary embodiment, by determining and quantifying the tightening of nuts 50, 54 (e.g., ft.-lbs. of torque), and by combining any number of conical spring washers 61 in various series and parallel arrangements, the amount of compression of conical spring washers 47, 51 against rotor body 15 may be accurately adjusted to assure the structural integrity of a rotor core 15 composed of individual laminations, and to set the spring force to provide a pressure relief when internal pressure in cavities 55, 56 creates a force greater than such spring force. By optimizing this spring force, and the associated profile of dynamic conical spring washer performance, individual laminations of rotor body 15 are held together, interior permanent magnets are cooled, and internal coolant pressure is partially controlled. During normal operation, the partial pressure control is effected by the expelling of coolant through nozzles 57, 58. By varying the quantity and diameter of nozzles 57, 58, the flow rate and pressure release are controlled. Additional pressure control devices (not shown) may be provided in a coolant pump and associated valves or the like. Further, the composition, shape, size and other specifications related to conical spring washer 61 act to control pressure. For example, the tightening of nuts 50, 54, the material composition of bending portions thereof, and the number of individual conical spring washers 61 determine an amount of deflection and resultant partial pressure control.

A suitable coolant may include transmission fluid, ethylene glycol, an ethylene glycol/water mixture, water, oil, motor oil, a gas, a mist, any combination thereof, or another substance.

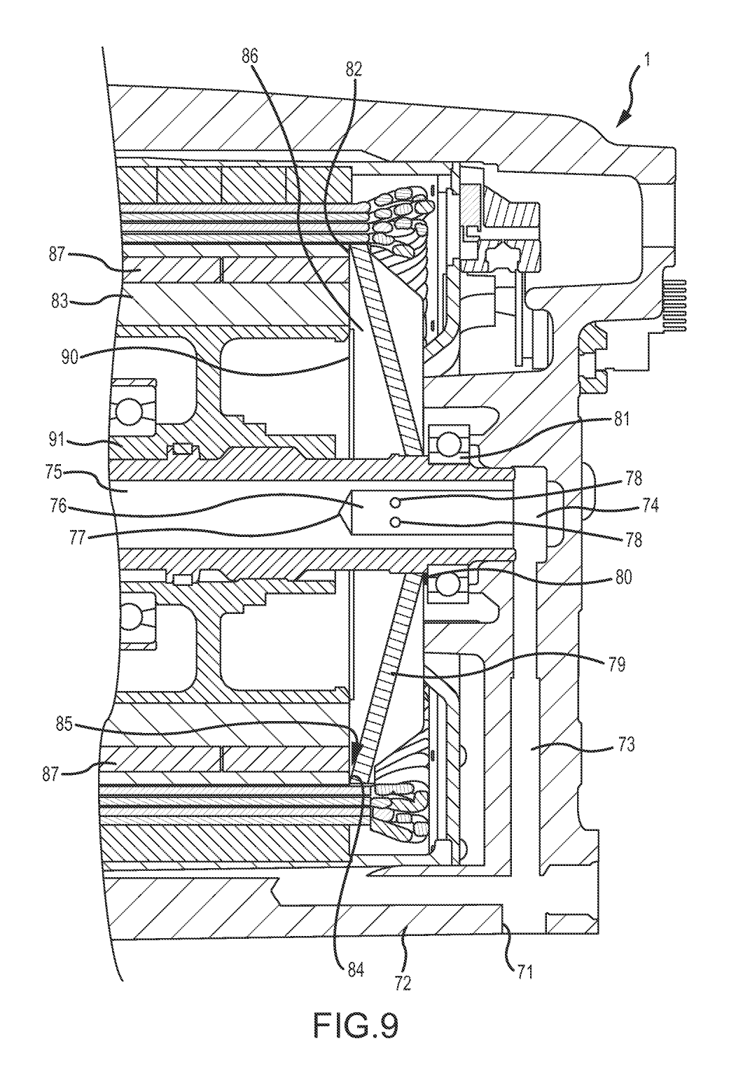

FIG. 9 is a cross-sectional view of an electric machine 1 having a coolant system that utilizes a conical spring washer, according to an exemplary embodiment. A coolant inlet port 71 is provided in housing 72 for attachment of a coolant hose or tube (not shown). Inlet 71 may include threads or other coupling structure for mating with an end connector of the coolant hose. A radially extending bore 73 provides a coolant passageway between inlet 71 and an annular inner chamber 74 formed as an integral part of housing 72. The inner diameter of chamber 74 is slightly larger than the outer diameter of shaft 75, whereby shaft 75 freely rotates. Shaft 75 has a center bore 76 that extends from a proximate end within chamber 74 to a location 77 that may be determined based on the diameter of bore 76, on balancing and strength of shaft 75, and on other criteria. A series of holes 78, for example 3 mm, extend radially from bore 76 through the outer circumferential surface of shaft 75. A conical spring washer 79 has an annular inner rim 80 coupled to a rotating inner portion of bearing assembly 81. The non-rotating, fixed portion of bearing assembly 81 is securely mounted to housing 72. The annular, axially inward surface 82 of conical spring washer 79 is biased against the axially outer surface 84 of rotor core 83 by its abutment with bearing assembly 81 or, alternatively, by being secured to shaft 75 by a nut and washer (not shown) or by another structure. As a result of conical spring washer 79 being pressed against surface 84, an annular gap 85 fluidly connects the chamber 86 under the dome of conical spring washer 79 with longitudinally extending fluid channels 87 formed in rotor core 83. Fluid channels 87 may also contain permanent magnets 22, 32, 42, 43 (FIG. 6). Cover plate(s) 90 may be attached to axial ends of a hub 91, such as by being sealed and/or secured thereto.

In operation, coolant such as oil is pumped into inlet 71. The coolant quickly fills bore 73, chamber 74, bore 76, chamber 76, and channels 87. The coolant is then ejected through nozzle blocks (not shown) in a manner where the coolant sprays onto end turns of the stator windings. The coolant then exits electric machine 1 through a sump area (not shown) within housing 72 so that heat may be removed by an external heat exchanger. The entire coolant pathway may be formed to avoid or reduce void spaces because an undesirable collection of oil in such void spaces of a rotor can lead to an unbalancing of the rotor.

In an exemplary embodiment, stator coils 3 may be formed as individual conductor segments (not shown) that are welded together after being inserted into a stator core. Such coils are thereby formed to have a weld end and a crown end. Due to the geometry necessary for creating welding surfaces and other logistical reasons, the weld end of stator coils 3 is generally hotter than the crown end. As a result, the coolant expelled from rotor assembly 20 (FIG. 6) is typically sprayed by nozzles 57, 58 onto the weld ends of stator coils 3. For example, the coolant expelled from nozzles 57, 58 may be 80° C., but the weld ends' temperature may be 180° C. or more, so the expelled coolant heated by being passed through magnet channels 17, 19, 21, 23 and cavities 55, 56 provides a great deal of cooling for such weld end conductors even after cooling permanent magnets 10. The hot coolant is then typically collected in a sump portion (not shown) of housing 8 of electric machine 1 and is cooled in a heat exchanger such as a radiator type oil cooler. A coolant pump (not shown) then supplies the cooled coolant back to inlet 45.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A rotor of an internal permanent magnet (IPM) electric machine, comprising:
a core having first and second axial ends, longitudinal channels extending between the ends, and a plurality of permanent magnets disposed in the channels;
a first conical spring washer having a circumferential edge secured to the first axial end; and
a second conical spring washer having a circumferential edge secured to the second axial end;
wherein space between the first conical spring washer and the first axial end is in fluid communication, via the channels, with space between the second conical spring washer and the second axial end.

2. The rotor of claim 1, wherein the permanent magnets are axially segmented.

3. The rotor of claim 1, further comprising a shaft partially disposed in the core and having an outer surface, a center bore, and at least one hole extending radially from the center bore to the outer surface, wherein the first conical spring washer encloses the at least one hole.

4. The rotor of claim 3, wherein the second conical spring washer has at least one exit aperture.

5. The rotor of claim 4, wherein the at least one exit aperture comprises a series of nozzles.

6. The rotor of claim 5, wherein the nozzles include at least two different nozzle sizes.

7. The rotor of claim 1, wherein the conical spring washers are biased against the core with a force, wherein pressure within the spaces exceeding the force moves the conical spring washers away from the axial ends until such excess pressure is removed.

8. The rotor of claim 1, wherein at least one of the first and second conical spring washers includes a plurality of individual conical spring washers arranged as a series.

9. The rotor of claim 8, further comprising a spring carrier structured for spacing adjacent ones of the individual conical spring washers apart from one another.

10. A method, comprising:
stacking and aligning laminations on a shaft to thereby form a rotor core;
placing a conical spring washer onto the shaft at each axial end of the lamination stack; and
tightening the conical spring washers onto the shaft, whereby the conical spring washers compress the lamination stack.

11. The method of claim 10, wherein the stacking and aligning of laminations forms longitudinal coolant channels in the rotor core, and wherein the placing of the conical spring washers forms a cavity adjoining each axial end of the rotor core, the method further comprising filling the coolant channels and cavities with coolant.

12. The method of claim 11, further comprising pressurizing the coolant so that one of the cavities acts as a push amplifier and the other cavity acts as a pull amplifier for flowing the coolant through the lamination stack.

13. The method of claim 12, further comprising providing at least one opening in one of the conical spring washers, thereby reducing a pressure in the associated cavity creating the pull action.

14. A method of cooling magnets of an internal permanent magnet (IPM) electric machine, comprising:
enclosing each axial end of a rotor core with a conical spring washer to form two respective end cavities; and
transferring coolant between the end cavities, thereby passing the coolant by the magnets.

15. The method of claim 14, further comprising maintaining pressure within a coolant space that includes the end cavities.

16. The method of claim 15, further comprising tensioning the conical spring washers against the respective axial ends so that pressure exceeding a threshold causes the conical spring washers to move away from the axial ends until excess pressure is removed.

17. The method of claim 15, wherein the maintaining of pressure includes pumping the coolant into one of the end cavities.

18. The method of claim 15, wherein the maintaining of pressure includes regulating the pressure.

19. The method of claim 18, wherein the regulating of pressure includes providing at least one exit nozzle in one of the conical spring washers for discharging coolant.

20. The method of claim 19, wherein the at least one exit nozzle comprises a series of exit nozzles having at least two different flow volume settings.
